(19) United States
(12) Patent Application Publication
(10) Pub. No.: US 2026/0113689 A1
(43) Pub. Date: Apr. 23, 2026

(54) CAG EXTENSION FOR MOBILE IAB-NODE

(71) Applicant: Telefonaktiebolaget LM Ericsson (publ), Stockholm (SE)

(72) Inventors: Qian CHEN, MÖLNDAL (SE); Paul SCHLIWA-BERTLING, LJUNGSBRO (SE); Ritesh SHREEVASTAV, UPPLANDS VÄSBY (SE); Antonino ORSINO, KIRKKONUMMI (FI)

(73) Assignee: Telefonaktiebolaget LM Ericsson (publ), Stockholm (SE)

(21) Appl. No.: 19/102,404

(22) PCT Filed: Aug. 4, 2023
(86) PCT No.: PCT/EP2023/071734

§ 371 Date: Feb. 9, 2025

Related U.S. Application Data
(60) Provisional application No. 63/396,237, filed on Aug. 9, 2022.

(51) Int. Cl. H04W 48/02; H04W 60/04; H04W 64/00; H04W 76/20

(52) U.S. Cl. CPC H04W 48/02; H04W 60/04; H04W 64/00; H04W 76/20

(57) ABSTRACT

A method performed by a user equipment (UE) includes receiving a closed access group (CAG) configuration from a wireless communication network, receiving extended CAG configuration information that indicates a validity condition under which the CAG configuration should be considered valid or not valid by the UE, and applying the CAG configuration based on the indicated validity condition. A method performed by a network node includes sending a CAG configuration to a UE and sending extended CAG configuration information to the UE that indicates a validity condition under which the CAG configuration should be considered valid or not valid by the UE.

### TECHNICAL FIELD

The present disclosure relates to wireless communication networks, and in particular to closed access group (CAG) configurations for integrated access and backhaul (IAB).

### BACKGROUND

In Figth Generation (5G) communication systems (5GS), the integrated access and backhaul (IAB) architecture is supported as specified in clause 5.35 of [1]. An IAB-node can be connected to a 5G system via an IAB-donor node first. Then, user equipments (UEs) can connect to IAB-node, which provide the access to 5G system.

### Integrated Access and Backhaul Overview

5G networks are being designed and deployed considering a dense deployment of small cells in order to simultaneously serve more UEs with higher throughput and lower delay. However, building a completely new infrastructure from scratch is costly and takes time. Deploying a wireless backhaul is envisioned to be an economically and technically viable approach to enable buildout of flexible and dense networks.

The IAB solution was standardized in 3GPP Release 16 to support wireless relaying in NG-RAN, and has continued in 3GPP Release 17.

### IAB Architecture

IAB is based on the central unit (CU)-distributed unit (DU) split that was standardized in 3GPP Release 15. The CU is in charge of the radio resource control (RRC) and the packet data convergence (PCDP) protocols, whereas the distributed unit (DU) is in charge of the radio link control (RLC) and multiple access control (MAC) protocols. The F1 interface connects the CU and the DU. The CU-DU split facilitates separate physical CU and DU, while also allowing a single CU to be connected to multiple DUs.

The main components of the IAB architecture are an IAB node and an IAB donor. An IAB node is a node that allows wireless access to the UEs while also backhauling the traffic to other nodes. An IAB node consists of a DU that provides access to connected UEs. The IAB node also consists of a mobile termination (MT) that connects to other IAB nodes or donors in the uplink direction for backhaul. An IAB donor is a node that provides UEs an interface to the core network and provides wireless functionality to other IAB-nodes to backhaul their traffic to the core network. FIG. 1 shows an example of the basic architecture of IAB.

The architecture shown in FIG. 1 consists of a single IAB donor 10 connected to a core network (CN) 40. The IAB donor 10 includes a CU-CP 14 to handle control plane (CP) functions and a CU-UP 16 to handle user plane (UP) functionality, in addition to other functions. The IAB donor 10 serves three direct IAB child nodes 20A, 20B, 20C through two co-located DUs 12A, 12B at the IAB donor 10 for wireless backhauling. The center IAB node 20B in turn serves two IAB nodes 20D, 20E through a wireless backhaul. All IAB nodes in FIG. 1 handle backhaul traffic, including traffic related to UEs connected to it and other backhaul traffic from downstream IAB nodes.

In 3GPP Release 16, IAB was standardized with basic support for multi-hop multi-path backhaul for directed acyclic graph (DAG) topology. No mesh-based topology was supported. 3GPP Release 16 also supports quality of service (QoS) prioritization of backhaul traffic and flexible resource usage between access and backhaul. Current discussions in 3GPP Release 17 are on topology enhancements for IAB with partial migration of IAB nodes for radio link failure (RLF) recovery and load balancing.

In 3GPP Release 18, it is expected that the different RAN groups will work towards enhancing functionality of IAB through focus on mobile-IAB/vehicle mounted relays (VMR) providing 5G coverage enhancement.

### SUMMARY

A method performed by a user equipment, UE, includes receiving a closed access group, CAG, configuration from a wireless communication network, receiving extended CAG configuration information that indicates a validity condition under which the CAG configuration should be considered valid or not valid by the UE, and applying the CAG configuration based on the indicated validity condition.

The extended CAG configuration information may include a duration during which the CAG configuration received should be considered valid by the UE.

The CAG configuration may include a plurality of CAG IDs, and the time duration may be common for all CAG IDs received by the UE. The time duration may be measured by a one-shot timer, wherein the CAG configuration is not valid after expiration of the one-shot timer. The time duration may be measured by a timer that is started by the UE upon receiving the CAG configuration for a first time. When the timer expires, it may be restarted again upon an indication from the network.

In some embodiments, the timer may be started only upon an indication from the network.

In various embodiments, the validity condition may include at least one of: a geographical location in which the CAG configuration received should be considered valid by the UE, a tracking area, TA, or a list of TAs, where the CAG configuration received should be considered valid by the UE, a registration area, RA, or a list of RAs, where the CAG configuration received should be considered valid by the UE, a radio access node, RAN, notification area, RNA, or a list of RNAs, where the CAG configuration received should be considered valid by the UE, or an indication for the UE where the CAG configuration received should be considered valid, or not valid, by the UE.

The geographical location may include a list of geographical coordinates. In some embodiments, the geographical location includes a set of geographical coordinates that represent a certain area.

The extended CAG configuration information may apply to a single CAG ID configured at the UE.

The CAG configuration may include a plurality of CAG IDs, and the extended CAG configuration information may be common for all CAG IDs received by the UE.

The extended CAG configuration is received from the mobile IAB node. In some embodiments the extended CAG configuration may be received in a container generated by an access and mobility function, AMF.

The method may further include providing user data, and forwarding the user data to a host via the transmission to the network node.

The extended CAG configuration information may be received in non-access stratum, NAS, signalling or in radio resource control, RRC, signalling.

The network node may be a mobile integrated access and backhaul, IAB, node.

Some embodiments provide a method performed by a network node. The method includes sending a closed access group, CAG, configuration to a user equipment, UE, and sending extended CAG configuration information to the UE that indicates a validity condition under which the CAG configuration should be considered valid or not valid by the UE.

The method may further include obtaining user data, and forwarding the user data to a host or a user equipment.

Some embodiments provide a unified data management, UDM, function of a core network of a wireless communication system that is configured to provide extended CAG configuration information that indicates a validity condition under which a closed access group, CAG, configuration should be considered valid or not valid by a user equipment, UE, to an access and mobility management function, AMF, along with subscription data related to the UE.

Some embodiments provide an access and mobility management function, AMF, of a core network of a wireless communication system that is configured to receive extended CAG configuration information that indicates a validity condition under which a closed access group, CAG, configuration should be considered valid or not valid by a user equipment, UE, from a unified data management, UDM, function along with subscription data related to the UE, and send the extended CAG configuration information toward the UE.

A UE according to some embodiments includes a processing circuit, a transceiver coupled to the processing circuit, and a memory coupled to the processing circuit. The memory includes computer-readable programming instructions that, when executed by the processing circuit, cause the UE to perform operations including receiving a closed access group, CAG, configuration from a wireless communication network, receiving extended CAG configuration information that indicates a validity condition under which the CAG configuration should be considered valid or not valid by the UE, and applying the CAG configuration based on the indicated validity condition.

A network node according to some embodiments includes a processing circuit, a transceiver coupled to the processing circuit, and a memory coupled to the processing circuit. The memory includes computer-readable programming instructions that, when executed by the processing circuit, cause the network node to perform operations including sending a closed access group, CAG, configuration to a user equipment, UE, and sending extended CAG configuration information to the UE that indicates a validity condition under which the CAG configuration should be considered valid or not valid by the UE.

### BRIEF DESCRIPTION OF THE DRAWINGS

FIG. 1 illustrates shows an example of the basic architecture of IAB.

FIGS. 2 and 3 illustrate a possible structure of a CAG Information List Information Element according to some embodiments.

FIG. 4 is a flowchart of operations performed by a UE according to some embodiments.

FIG. 5 is a flowchart of operations performed by a network node according to some embodiments.

FIG. 6 shows an example of a communication system in accordance with some embodiments.

FIG. 7 shows an example of a UE in accordance with some embodiments.

FIG. 8 shows an example of a network node in accordance with some embodiments.

FIG. 9 shows an example of a host node in accordance with some embodiments.

FIG. 10 is a block diagram illustrating a virtualization environment in which functions implemented by some embodiments may be virtualized.

FIG. 11 shows a communication diagram of a host communicating via a network node with a UE over a partially wireless connection in accordance with some embodiments.

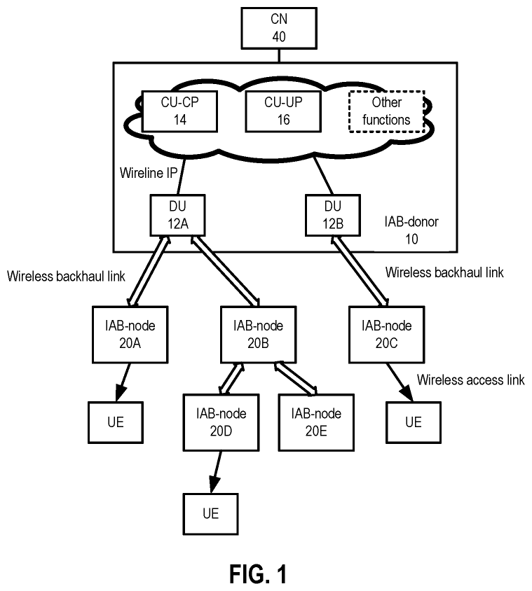

### DESCRIPTION OF EMBODIMENTS

One of the main use cases of mobile IAB cell is to serve UEs that reside in a vehicle with a vehicle mounted relay. Other relevant use cases for mobile IABs involve a mobile/nomadic IAB network node mounted on a vehicle that provides extended coverage for scenarios in which additional coverage is needed during special events such as concerts, during disasters, etc. The nomadic IAB node provides access to surrounding UEs while the backhaul traffic from the nomadic IAB node is then transmitted wirelessly either with the help of IAB donors or non-terrestrial networks (NTN). A nomadic IAB node may also reduce or even eliminate signal strength loss due to vehicle penetration for UEs that are present in the vehicles.

Some advantages of mobile IAB include reducing/eliminating vehicle penetration loss (especially at high frequency) and reducing/eliminating group handover.

There currently exist certain challenge(s). Supporting an IAB-node which can move is part of the Rel-18 study item FS_VMR in SA2. The key issues and solutions are documented in [3]. In [3], VMR stands for “Vehicle Mounted Relay” and MBSR stands for “Mobile Base Station Relay.” A VMR or MBSR is a RAN relay node that can move. In the SA2 study, it has been agreed that existing IAB architecture will be used as a base for the study. This means the IAB-node is equivalent to the VMR/MBSR, but it can move. Accordingly, the terms VMR, MBSR, and IAB-node may be used interchangeably.

Key Issue 7 described in [3] relates to how to control the access of a mobile IAB-node by a UE. Some embodiments described herein may provide solutions to these or other challenges. In particular, some embodiments described herein enhance the closed access group (CAG) functionality with a flag in subscription data to indicate whether or not a UE is allowed to access the IAB-node.

That is, a flag (or a well-known CAG ID) in the subscription data may indicate whether or not a UE is allowed to access the IAB-node. The CAG information may also include the applicable time duration and the applicable location (e.g. certain geographic area or tracking area identities (TAIs).

The access and mobility function (AMF) of the 5G core network shall translate the flag, if it is used, to a CAG identifier (ID) that is applicable for the mobile IAB-node in the serving public land mobile network (PLMN). The AMF also provides CAG ID related information to the radio access network (RAN) for mobility related control.

The flag and applicable duration/location can be provided by AMF to a unified data management (UDM) function using the parameter provision procedure as specified in 3GPP.

In addition, a mobile IAB can provide a CAG ID or a list of CAG ID that are related to a mobile IAB and that the UE should consider to determine whether or not it can access a cell (that is hosted by the mobile IAB).

Accordingly, some embodiments provide a solution based on the existing CAG concept with limited extensions to control the access of mobile IAB-node for UE. Because the solutions require a limited extension of an existing concept, the impact on the overall system may be limited.

Some of the embodiments contemplated herein will now be described more fully with reference to the accompanying drawings. Embodiments are provided by way of example to convey the scope of the subject matter to those skilled in the art.

### CAG Based UE Access Control Via IAB Node

Some embodiments described herein relate to KI #7 “Control of UE's access to 5GS via a mobile base station relay”. In particular, some embodiments described herein use the existing CAG, Closed Access Group, concept as a base to manage the UE access control via IAB node.

There are certain simplifications on the existing CAG logic to fit into the IAB architecture.

### Functional Description

When a UE tries to connect to 5GS via a mobile IAB-node, the access control of the UE is managed by CN, RAN and optionally UE. During the CM-CONNECTED mobility, the access control via mobile IAB-node is managed by CN and RAN.

According to some embodiments, a new CAG identifier (or IAB CAG Identifier) is assigned in the network. The new CAG identifier is supported by the cells covered by the IAB-node. Considering the roaming IAB-node scenario, this new IAB CAG Identifier in subscription data in UDM is defined as a “common” or “well-known” CAG identifier or just flag which can be interpreted by different PLMNs in the same way that UE is allowed to access the cell supports the IAB CAG Identifier in the current network.

RAN and CN supports the UE access control based on the new IAB CAG identifier supported by the cell and the allowed CAG identifiers in the network for the UE.

For UEs that support CAG, it may select the cells covered by IAB-node using the existing CAG control logic. For the UEs that do not support CAG (i.e. the UE is not able to realize the broadcasted CAG information by the cell) but supports the use of IAB architecture, it may select the cell covered by IAB-node as normal and rely on RAN and CN to control the IAB-node access using CAG control logic.

Considering the IAB-node access use case, additional control (e.g., time duration, specific geographic location) may be linked to the IAB CAG identifier management, e.g., when user purchase a buss/train ticket, the access to IAB-node/IAB CAG identifier may be limited to certain time period and specific locations and granted to the user subscription data via AF/NEF or O&M.

Note that it is assumed that the serving PLMN that hosts the mobile IAB-node is configured to support the needed roaming interfaces towards all HPLMNs of the UEs which are allowed to access the serving PLMN via mobile IAB-node.

The CAG control is well described in different procedures in TS 23.502 [5]. Procedure details may be updated to the additional control in case of IAB CAG Identifier e.g. time duration or specific geographic location.

### Impacts on Services, Entities and Interfaces

The AMF supports CAG control with linkage to additional controls (e.g. time duration, geographic location.

The UDM supports CAG Identifier with linkage to additional controls (e.g. time duration, geographic location).

The gNB/IAB-node supports CAG function.

The UE supports CAG function.

Some examples of updates to interfaces used to achieve the functions listed above will now be described.

A Mobility Restriction List information element (IE) as shown in Table 1 may define roaming or access restrictions for subsequent mobility action for which the NG-RAN provides information about the target of the mobility action towards the UE, e.g., handover, or for SCG selection during dual connectivity operation or for assigning proper RNAs. NG-RAN behavior upon receiving this IE is specified in TS 23.501 [9].

TABLE 1
Mobility Restriction List IE

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Serving PLMN | M | PLMN Identity | — | |
| | | 9.3.3.5 | | |
| . . . | | | | |
| NPN Mobility Information | O | 9.3.1.184 | YES | reject |
| Mobile IAB Mobility | O | 9.3.1.XX | YES | reject |
| Information | | | | |

An NPN Mobility Information IE as shown in Table 2 indicates the access restrictions related to an NPN.

TABLE 2
NPN Mobility Information IE

| | | | | |
|---|---|---|---|---|
| | | | IE type and | |
| IE/Group Name | Presence | Range | reference | Semantics description |

| | | |
|---|---|---|
| CHOICE NPN Mobility | M | |
| Information | | |
| >SNPN Mobility Information | | |
| >>Serving NID | M | NID |
| | | 9.3.3.42 |
| >PNI-NPN Mobility | | |
| Information | | |
| >>Allowed PNI-NPN List | M | 9.3.3.45 |

An Allowed PNI-NPN List IE as shown in Table 3 contains information on allowed UE mobility in PNI-NPN including allowed PNI-NPNs and whether the UE is allowed to access non-CAG cells for each PLMN.

TABLE 3
Allowed PNI-NPN List IE

| | | | IE type and | |
|---|---|---|---|---|
| IE/Group Name | Presence | Range | reference | Semantics description |
| Allowed PNI-NPN Item | | 1 . . . <maxnoofEPLMNs + 1> | | |
| >PLMN Identity | M | | 9.3.3.5 | |
| >PNI-NPN Restricted | M | | ENUMERATED | If set to “restricted”, indicates that |
| | | | (restricted, not- | the UE is not allowed to access |
| | | | restricted, | non-CAG cells for this PLMN. |
| | | | . . . ) | |
| >Allowed CAG List per | | 1 . . . | | |
| PLMN | | <maxnoofAllowedCAGsperPLMN> | | |
| >>CAG ID | M | | 9.3.3.43 | |
| >> Duration | O | | xx | It specifies the applicable time |
| | | | | period of CAG ID. |
| >> Area | O | | xx | It specifies the applicable area of |
| | | | | the CAG ID (e.g. TAI/CGI list). |
| >>> TAC List | O | | | It specifies the applicable |
| | | | | Tracking area list (mobile IAB |
| | | | | specific TAC) of the CAG ID |
| >>> Cell List | O | | | It specifies the applicable cell Id |
| | | | | list (mobile IAB cells) of the CAG |
| | | | | ID |

A Mobile IAB Mobility Information IE as shown in Table 4 contains information on allowed UE mobility in PNI-NPN including allowed PNI-NPNs and whether the UE is allowed to access non-CAG cells for each PLMN.

TABLE 4
Mobile IAB Mobility Information IE

| | | | IE type and | |
|---|---|---|---|---|
| IE/Group Name | Presence | Range | reference | Semantics description |
| Allowed PLMN Item | | 1 . . . <maxnoofEPLMNs + 1> | | |
| >PLMN Identity | M | | 9.3.3.5 | |
| >mobile IAB Restricted | M | | ENUMERATED | If set to “restricted”, indicates that |
| | | | (restricted, not- | the UE is not allowed to access |
| | | | restricted, | non-CAG cells for this PLMN. |
| | | | . . . ) | |
| >Allowed CAG List per | | 1 . . . | | |
| PLMN | | <maxnoofAllowedCAGsperPLMN> | | |
| >>CAG ID | M | | 9.3.3.43 | |
| >> Duration | O | | xx | It specifies the applicable time |
| | | | | period of CAG ID. |
| >> Area | O | | xx | It specifies the applicable area of |
| | | | | the CAG ID (e.g. TAI/CGI list). |
| >>> TAC List | O | | | It specifies the applicable |
| | | | | Tracking area list (mobile IAB |
| | | | | specific TAC) of the CAG ID |
| >>> Cell List | O | | | It specifies the applicable cell Id |
| | | | | list (mobile IAB cells) of the CAG |
| | | | | ID |

On NAS (TS 24.501), NAS messages with CAG IE (used by several messages) can be updated to include extra CAG related information.

A CAG information list IE may provide a “CAG information list” or delete the “CAG information list” at the UE.

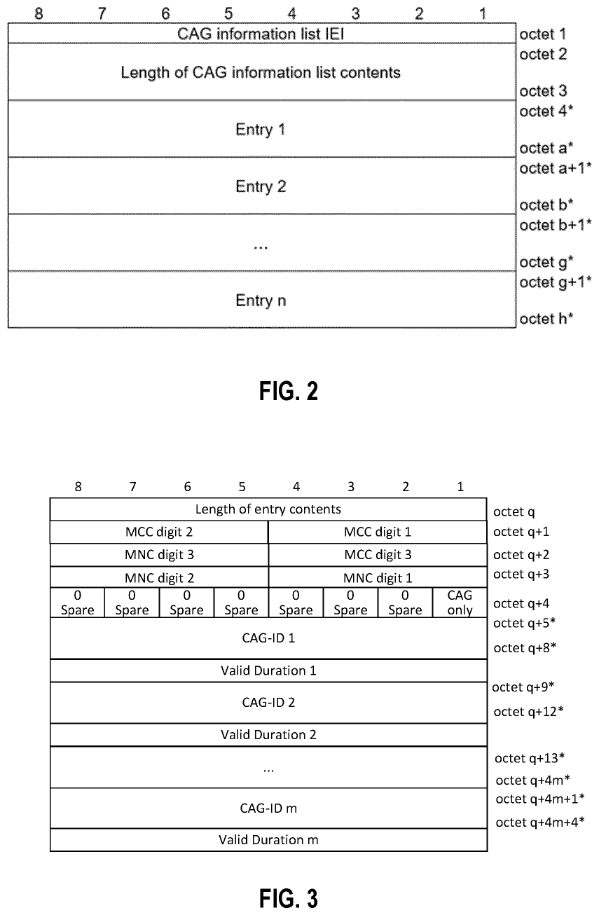

The CAG information list information element may be coded as shown in FIGS. 2 and 3, and Table 5.

TABLE 5
CAG information list IE

MCC, Mobile country code (octet q+1 and bits 1 to 4 octet q+2)
The MCC field is coded as in ITU-T Recommendation E.212 [42], annex A.
MNC, Mobile network code (bits 5 to 8 of octet q+2 and octet q+3)
The coding of this field is the responsibility of each administration, but BCD coding shall be used.
The MNC shall consist of 2 or 3 digits. If a network operator decides to use only two digits in the
MNC, bits 5 to 8 of octet q+2 shall be coded as “1111”.
The MCC and MNC digits are coded as octets 6 to 8 of the Temporary mobile group identity IE in
figure 10.5.154 of 3GPP TS 24.008 [12].
Indication that the UE is only allowed to access 5GS via CAG cells (CAGonly) (bit 1 of octet q+4)
Bit

| | |
|---|---|
| 1 | |
| 0 | “Indication that the UE is only allowed to access 5GS via CAG cells” is not set (i.e., the UE |
| | is allowed to access 5GS via non-CAG cells) |
| 1 | “Indication that the UE is only allowed to access 5GS via CAG cells” is set (i.e., the UE is |
| | not allowed to access 5GS via non-CAG cells) |

Validity duration (octets xx)
This field contains the duration for which the CAG ID is applicable.

The CAG information list is a type 6 information element, with a minimum length of 3 octets.

The interface between AF/NEF, and NEF/UDM/AMF can be updated with a message or IE to support the control of UE accessing mobile IAB node using subscription data.

In “AccessAndMobilitySubscriptionData” parameter (clause 6.1.6.2.4 of TS 29.503) from UDM to AMF, a new parameter (e.g. IAB access information) can be added as shown in Table 6 or the current CagData can be improved shown in Tables 7-9.

TABLE 6
Definition of type AccessAndMobility SubscriptionData

| Attribute name | Data type | P | Cardinality | Description | Applicability |
|---|---|---|---|---|---|
| supportedFeatures | SupportedFeatures | O | 0 . . . 1 | See clause 6.1.8 | |
| . . . | | | | | |
| traceData | TraceData | O | 0 . . . 1 | Trace requirements about the UE, only sent | |
| | | | | to AMF in the HPLMN or one of its equivalent | |
| | | | | PLMN(s) | |
| cagData | CagData | O | 0 . . . 1 | Closed Access Group Data. | CAGFeature |
| | | | | Shall be absent if both | |
| | | | | no CAG is subscribed for the serving PLMN | |
| | | | | and | |
| | | | | an acknowledgement from the UE is not | |
| | | | | pending. | |
| . . . | | | | | |
| IAB (or | IABAccessInformation | O | 0 . . . 1 | Indicates if a UE accessing IAB node is | |
| VMR/MBSR) | | | | allowed. | |
| access information | | | | | |

TABLE 7
Definition of CagData

| Attribute name | Data type | P | Cardinality | Description |
|---|---|---|---|---|
| cagInfos | map(CagInfo) | M | 0 . . . N | A map (list of key-value pairs where PlmnId converted to |
| | | | | string serves as key; see 3GPP TS 29.571 [7]) of CagInfo |
| | | | | An empty map indicates that for no PLMN CAG is |
| | | | | subscribed and shall only be sent when provisioningTime |
| | | | | is present (i.e. when acknowledgement from the UE is |
| | | | | pending). |
| | | | | If provisioningTime is present (i.e. the acknowledgement |
| | | | | from the UE is still pending), the complete map of CagInfo |
| | | | | (i.e. for all PLMNs) shall be present; otherwise only the |
| | | | | CagInfo relevant to the Serving PLMN should be present. |
| provisioningTime | DateTime | C | 0 . . . 1 | This attribute shall be present if the CagData is sent to the |
| | | | | AMF while reception has not yet been acknowledged from |
| | | | | the UE; otherwise shall be absent. Presence of this |
| | | | | attribute indicates that the AMF needs to update the UE |
| | | | | with the complete map of CagInfo. |
| | | | | This attribute serves as CAG information Subscription |
| | | | | Change Indication |

TABLE 8
Definition of type CagInfo

| Attribute name | Data type | P | Cardinality | Description |
|---|---|---|---|---|
| allowedCagList | array(CagId) | M | 1 . . . N | List of allowed CAG Ids. |
| cagOnlyIndicator | boolean | O | 0 . . . 1 | true indicates that the UE is restricted to only access 5GS |
| | | | | via CAG cells; |
| | | | | absence and false indicate that the UE is not restricted to |
| | | | | only access 5GS via CAG cells. |
| Duration | | O | | Indicates the applicable duration of the CAG ID |
| Area | | O | | Indicates the applicable area of the CAG ID (e.g. a |
| | | | | geographic area or a TAI/CGI list). If geographic area is |
| | | | | provided, the AMF translate it to TAI/CGI list before provide |
| | | | | to RAN and UE. |

TABLE 9
Definition of type IAB access information

| Attribute name | Data type | P | Cardinality | Description |
|---|---|---|---|---|
| IAB (or VMR/MBSR) | boolean | M | 0 . . . 1 | Indicates if access via IAB-node is allowed. The AMF in |
| access allowed | | | | serving PLMN maps this to applicable CAG IDs for mobile |
| | | | | IAB-access. |
| Duration | | O | | Indicates the applicable duration of the IAB access. |
| Area | | O | | Indicates the applicable area of the IAB access(e.g. a |
| | | | | geographic area or a TAI/CGI list). If geographic area is |
| | | | | provided, the AMF translate it to TAI/CGI list before |
| | | | | provide to RAN and UE. |

As shown in Table 10, in the “Ppdata” parameter (clause 6.5.6.2.2 of TS 29.503) from NEF to UDM, a new parameter (e.g. IAB access information) can be added. It shall be possible to define a standalone parameter to delivery IAB access related information (similar logic can be introduced for service operations from AF to NEF to delivery such information).

TABLE 10
Definition of PpData

| Attribute name | Data type | P | Cardinality | Description |
|---|---|---|---|---|
| supportedFeatures | SupportedFeatures | O | 0 . . . 1 | |
| communicationCharacteristics | CommunicationCharacteristics | O | 0 . . . 1 | communication characteristics |
| expectedUeBehaviour | ExpectedUeBehaviour | O | 0 . . . 1 | Expected UE Behaviour Parameters |
| ecRestriction | EcRestriction | O | 0 . . . 1 | Enhanced Coverage Restriction |
| | | | | Parameters |
| acsInfo | AcsInfoRm | O | 0 . . . 1 | Identifies the ACS Information (see |
| | | | | TS 23.316 [37] clause 9.6.3); nullable. |
| stnSr | StnSrRm | O | 0 . . . 1 | Session Transfer Number for SRVCC |
| lcsPrivacy | LcsPrivacy | O | 0 . . . 1 | LCS Privacy Parameters (see clause |
| | | | | 5.4.3 of 3GPP TS 23.273 [38]) |
| sorInfo | SorInfo | O | 0 . . . 1 | Steering of Roaming information to be |
| | | | | conveyed to a UE |
| | | | | See NOTE°1 and NOTE°2. |
| 5mbsAuthorizationInfo | 5MbsAuthorizationInfo | O | 0 . . . 1 | When present, this IE shall include the |
| | | | | 5MBS Session Authorization Information |
| | | | | as specified in 3GPP TS 23.247 [59] |
| IAB (or VMR/MBSR) | IABAccessInformation | O | | It indicates the IAB access related |
| Access information | | | | information |

NOTE°1:
If the UDM is not able to immediately (after conducting integrity protection with the AUSF) convey the received Steering of Roaming information to the concerned UE for any reason (e.g. no AMF registered for the UE), it shall discard it.
NOTE°2:
The behaviour of the UDM at reception of Steering of Roaming information within PpData is specified in Annex C.3 of 3GPP°TS°23.122°[20].

In the RRC system information broadcast, an IAB specific new SIB can be defined to broadcast the CAG configuration or existing SIB such as SIB1/SIB3/4 can be reused.

One way is to extent the below System Info defined in SIB1 for the IE cellAccessRelatedInfo to specify the CAG ID for mobile IAB.

The IE CellAccessRelatedInfo shown in Table 11 indicates cell access related information for this cell.

TABLE 11
CellAccessRelatedInfo Information Element

CellAccessRelatedInfo information element
-- ASN1START
-- TAG-CELLACCESSRELATEDINFO-START

| CellAccessRelatedInfo ::= | SEQUENCE { | |
|---|---|---|
| plmn-IdentityInfoList | PLMN-IdentityInfoList, | |
| cellReservedForOtherUse | ENUMERATED {true} | OPTIONAL, -- Need R |

```
  ...,
  [[
```

| | | |
|---|---|---|
| cellReservedForFutureUse-r16 | ENUMERATED {true} | OPTIONAL, -- Need R |

npn-IdentityInfoList-r16

| | | |
|---|---|---|
| ]], | NPN-IdentityInfoList-r16 | OPTIONAL -- Need R |

[[

| | |
|---|---|
| snpn-AccessInfoList-r17 | SEQUENCE (SIZE (1..maxNPN-r16)) OF SNPN-AccessInfo-r17 OPTIONAL -- Need |

```
R
  ]],
    [[
```

| | |
|---|---|
| cag-mIAB-IdentityList-r16 | SEQUENCE (SIZE (1..maxMobileIAB-r16)) OF CAG-IdentityInfo-r16 |

]]
}

| SNPN-AccessInfo-r17 ::= | SEQUENCE { | |
|---|---|---|
| extCH-Supported-r17 | ENUMERATED {true} | OPTIONAL, -- Need R |
| extCH-WithoutConfigAllowed-r17 | ENUMERATED {true} | OPTIONAL, -- Need R |
| onboardingEnabled-r17 | ENUMERATED {true} | OPTIONAL, -- Need R |
| imsEmergencySupportForSNPN-r17 | ENUMERATED {true} | OPTIONAL -- Need R |

}
-- TAG-CELLACCESSRELATEDINFO-STOP
-- ASN1STOP

| CAG-IdentityInfo-r16 ::= | SEQUENCE { | |
|---|---|---|
| cag-Identity-r16 | BIT STRING (SIZE (32)), | |
| manualCAGselectionAllowed-r16 | ENUMERATED {true} | OPTIONAL -- Need R |

}

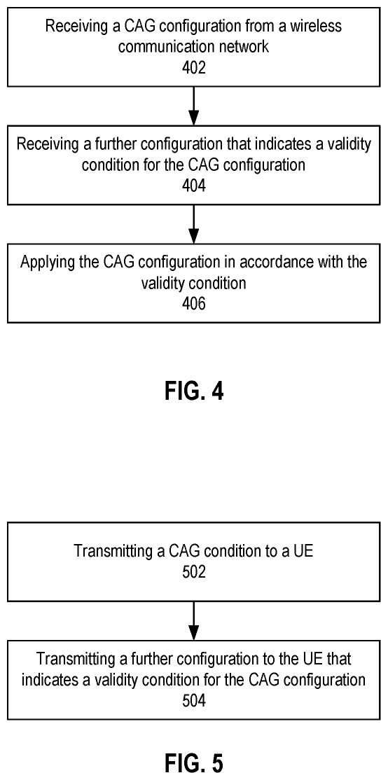

Referring to FIG. 4, in a method at a User Equipment (UE), the UE receives a CAG configuration from a mobile IAB (block 402), The UE receives extended CAG configuration information that indicates a validity condition for the CAG configuration (block 404), and applies the CAG configuration based on the indicated validity condition for the CAG configuration (block 406). The extended CAG configuration information may include one or the following:
A timer T1 (or time period) during which the CAG configuration received should be considered valid by the UE. In this case the timer can be common for all the CAG IDs received.
A geographical location in which the CAG configuration received should be considered valid by the UE.
A tracking area (TA) or a list of tracking areas where the CAG configuration received should be considered valid by the UE.
A registration area (RA) or a list of registration areas where the CAG configuration received should be considered valid by the UE.
A RAN notification areas (RNA) or a list of RAN notification areas where the CAG configuration received should be considered valid by the UE.
An indication for the UE where the CAG configuration received should be considered valid (or not valid) by the UE.

In one option, the timer T1 can be a one-shot timer, meaning that the UE starts T1 once and when T1 expires consider the CAG configuration as not valid anymore (and thus will delete it). In some embodiments, the timer can be a time period indicated by a pair of time stamps (e.g., time stamp 1 and time stamp 2) during which the CAG configuration is valid.

In one option, the timer T1 is started by the UE when receiving the first time the CAG configuration and, when it expires, is restarted again upon an indication from the network.

In one option, the timer T1 is started only upon an indication from the network.

In one option, the geographical location is simply a list of coordinates (e.g., longitude and latitude).

In one option, the geographical location is a set of coordinates that represent a certain area.

The different options described above can be provided for a single CAG ID configured at the UE or can be common for all the CAG IDs configured at the UEs.

CAG related information has two parts: (i) individual UE-related CAG information (referred to herein as extended CAG configuration information) and (ii) the supported CAG information broadcast by the RAN in the serving network, which is not related to individual UE CAG information.

The extended CAG configuration information may be transmitted from the UDM to the AMF as part of the subscription data, then from the AMF to the RAN (IAB-donor+IAB-node) and the UE. The information sent from the UDM to the AMF can be provided in different formats, including geographical coordinates. The information sent towards the UE/RAN may be translated to TAI/Cell information. The AMF is responsible for translating the geographical coordinates to TAIs/Cells if such data is received from the UDM.

The extended CAG configuration information may be delivered to the UE via a non-access stratum (NAS) message. Alternatively, the extended CAG configuration information may be provided using RRC signalling.

Accordingly, some embodiments provide a UDM configured to provide extended CAG configuration information, that indicates a validity condition under which a CAG configuration should be considered valid or not valid by the UE, to an AMF along with subscription data.

Some embodiments provide an AMF configured to support the extended CAG configuration information. In some embodiments, the AMF is configured to convert geographical coordinate data in the extended CAG configuration to TAI/cell information.

Some embodiments provide a RAN node configured to support the extended CAG configuration information.

Some embodiments provide a UE configured to receive the extend CAG configuration via NAS signalling or via RRC signalling.

Referring to FIG. 5, some embodiments provide a method performed by a mobile IAB. The mobile IAB sends a CAG configuration to a UE (block 502). The mobile IAB sends a further configuration that indicates a validity condition for the CAG configuration (i.e., a condition under which the CAG configuration should be considered valid or not valid by the UE) (block 504). In particular, the further configuration may comprise one or more of the following:
A timer T1 during which the CAG configuration received should be considered valid by the UE.
A geographical location in which the CAG configuration received should be considered valid by the UE.
A tracking area or a list of tracking areas where the CAG configuration received should be considered valid by the UE.
A registration area or a list of registration areas where the CAG configuration received should be considered valid by the UE.
A RAN notification areas or a list of RAN notification areas where the CAG configuration received should be considered valid by the UE.
An indication for the UE where the CAG configuration received should be considered valid (or not valid) by the UE.

In one option, the timer T1 can be a one-shot timer, meaning that the UE starts T1 once and when T1 expires consider the CAG configuration as not valid anymore (and thus will delete it).

In one option, the timer T1 is started by the UE when receiving the first time the CAG configuration and, when it expires, is restarted again upon an indication from the network.

In one option, the timer T1 is started only upon an indication from the network.

In one option, the geographical location is simply a list of coordinates (e.g., longitude and latitude).

In one option, the geographical location is a set of coordinate that represent a certain area.

Note that the different options described in the method can be provided for a single CAG ID configured at the UE or can be common for all the CAG IDs configured at the UEs.

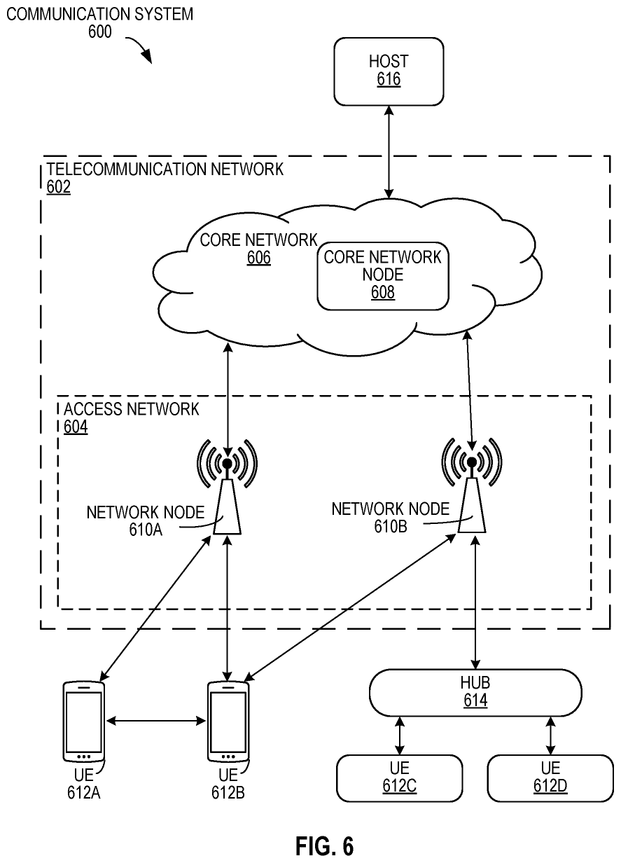

FIG. 6 shows an example of a communication system 600 in accordance with some embodiments.

In the example, the communication system 600 includes a telecommunication network 602 that includes an access network 604, such as a radio access network (RAN), and a core network 606, which includes one or more core network nodes 608. The access network 604 includes one or more access network nodes, such as network nodes 610a and 610b (one or more of which may be generally referred to as network nodes 610), or any other similar 3^{rd} Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 602 includes one or more Open-RAN (ORAN) network nodes. An ORAN network node is a node in the telecommunication network 602 that supports an ORAN specification (e.g., a specification published by the O-RAN Alliance, or any similar organization) and may operate alone or together with other nodes to implement one or more functionalities of any node in the telecommunication network 602, including one or more network nodes 610 and/or core network nodes 608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 610 facilitate direct or indirect connection of user equipment (UE), such as by connecting UEs 612a, 612b, 612c, and 612d (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 602 is a cellular network that implements 3GPP standardized features. Accordingly, the telecommunications network 602 may support network slicing to provide different logical networks to different devices that are connected to the telecommunication network 602. For example, the telecommunications network 602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 614 communicates with the access network 604 to facilitate indirect communication between one or more UEs (e.g., UE 612c and/or 612d) and network nodes (e.g., network node 610b). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a VR headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular if one or more of the UEs are low energy IoT devices.

The hub 614 may have a constant/persistent or intermittent connection to the network node 610b. The hub 614 may also allow for a different communication scheme and/or schedule between the hub 614 and UEs (e.g., UE 612c and/or 612d), and between the hub 614 and the core network 606. In other examples, the hub 614 is connected to the core network 606 and/or one or more UEs via a wired connection. Moreover, the hub 614 may be configured to connect to an M2M service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610b. In other embodiments, the hub 614 may be a non-dedicated hub—that is, a device which is capable of operating to route communications between the UEs and network node 610b, but which is additionally capable of operating as a communication start and/or end point for certain data channels.

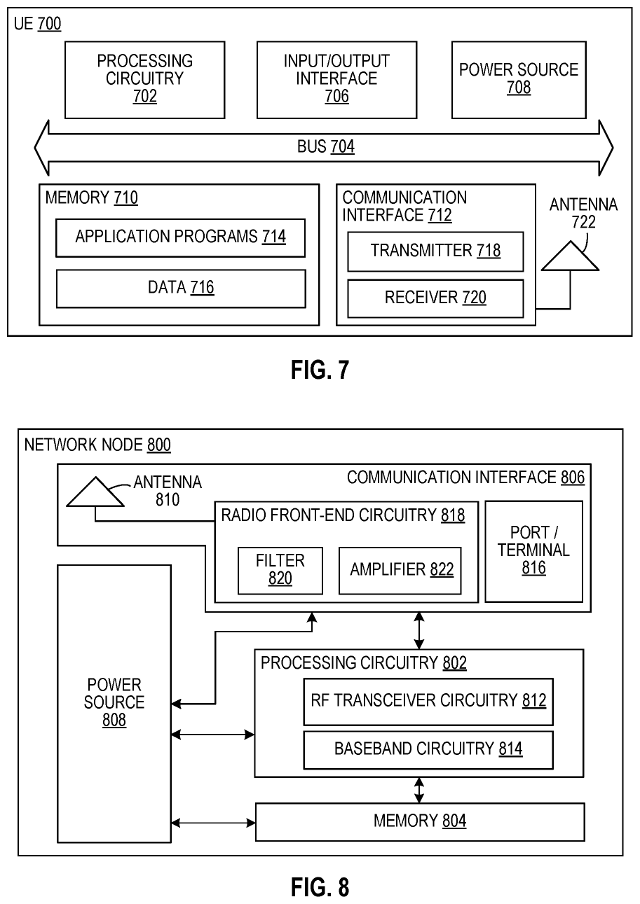

FIG. 7 shows a UE 700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, a memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 702 may include multiple central processing units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging of the power source 708. Power circuitry may perform any formatting, converting, or other modification to the power from the power source 708 to make the power suitable for the respective components of the UE 700 to which power is supplied.

The memory 710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 710 may allow the UE 700 to access instructions, application programs and the like, stored on transitory or non-transitory memory media, to off-load data, or to upload data. An article of manufacture, such as one utilizing a communication system may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., antenna 722) and may share circuit components, software or firmware, or alternatively be implemented separately.

In the illustrated embodiment, communication functions of the communication interface 712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 8 shows a network node 800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes a processing circuitry 802, a memory 804, a communication interface 806, and a power source 808. The network node 800 may be composed of multiple physically separate components (e.g., a NodeB component and a RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 800 may be configured to support multiple radio access technologies (RATs). In such embodiments, some components may be duplicated (e.g., separate memory 804 for different RATs) and some components may be reused (e.g., a same antenna 810 may be shared by different RATs). The network node 800 may also include multiple sets of the various illustrated components for different wireless technologies integrated into network node 800, for example GSM, WCDMA, LTE, NR, WiFi, Zigbcc, Z-wave, LoRaWAN, Radio Frequency Identification (RFID) or Bluetooth wireless technologies. These wireless technologies may be integrated into the same or different chip or set of chips and other components within network node 800.

The processing circuitry 802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 800 components, such as the memory 804, to provide network node 800 functionality.

In some embodiments, the processing circuitry 802 includes a system on a chip (SOC). In some embodiments, the processing circuitry 802 includes one or more of radio frequency (RF) transceiver circuitry 812 and baseband processing circuitry 814. In some embodiments, the radio frequency (RF) transceiver circuitry 812 and the baseband processing circuitry 814 may be on separate chips (or sets of chips), boards, or units, such as radio units and digital units. In alternative embodiments, part or all of RF transceiver circuitry 812 and baseband processing circuitry 814 may be on the same chip or set of chips, boards, or units.

The memory 804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and memory 804 is integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. Radio front-end circuitry 818 comprises filters 820 and amplifiers 822. The radio front-end circuitry 818 may be connected to an antenna 810 and processing circuitry 802. The radio front-end circuitry may be configured to condition signals communicated between antenna 810 and processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of filters 820 and/or amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface may comprise different components and/or different combinations of components.

In certain alternative embodiments, the network node 800 does not include separate radio front-end circuitry 818, instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes one or more ports or terminals 816, the radio front-end circuitry 818, and the RF transceiver circuitry 812, as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, communication interface 806, and/or the processing circuitry 802 may be configured to perform any receiving operations and/or certain obtaining operations described herein as being performed by the network node. Any information, data and/or signals may be received from a UE, another network node and/or any other network equipment. Similarly, the antenna 810, the communication interface 806, and/or the processing circuitry 802 may be configured to perform any transmitting operations described herein as being performed by the network node. Any information, data and/or signals may be transmitted to a UE, another network node and/or any other network equipment.

The power source 808 provides power to the various components of network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid, an electricity outlet) via an input circuitry or interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

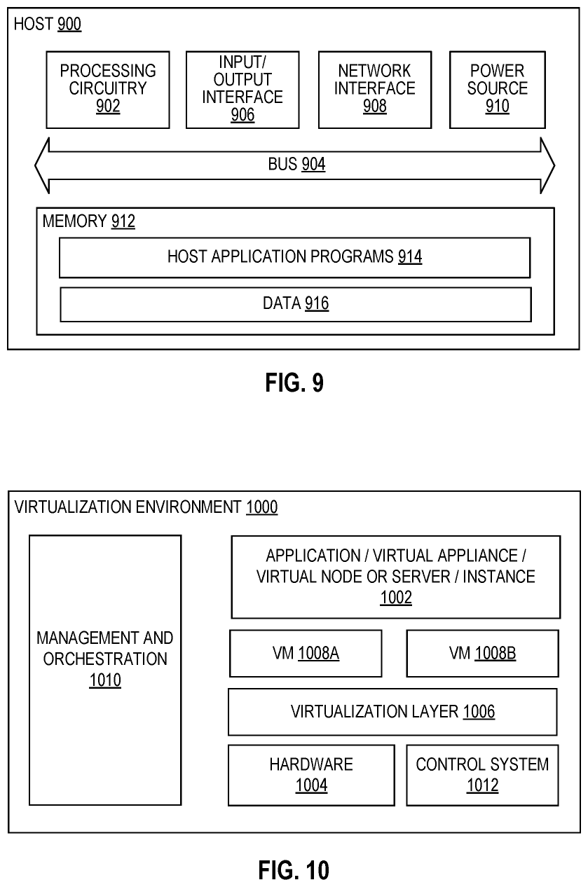

FIG. 9 is a block diagram of a host 900, which may be an embodiment of the host 616 of FIG. 6, in accordance with various aspects described herein. As used herein, the host 900 may be or comprise various combinations hardware and/or software, including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and a memory 912. Other components may be included in other embodiments. Features of these components may be substantially similar to those described with respect to the devices of previous figures, such as FIGS. 7 and 8, such that the descriptions thereof are generally applicable to the corresponding components of host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 914 may also provide for user authentication and licensing checks and may periodically report health, routes, and content availability to a central node, such as a device in or on the edge of a core network. Accordingly, the host 900 may select and/or indicate a different host for over-the-top services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1000 includes components defined by the O-RAN Alliance, such as an O-Cloud environment orchestrated by a Service Management and Orchestration Framework via an O-2 interface.

Applications 1002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or virtual machine monitors (VMMs)), provide VMs 1008a and 1008b (one or more of which may be generally referred to as VMs 1008), and/or perform any of the functions, features and/or benefits described in relation with some embodiments described herein. The virtualization layer 1006 may present a virtual operating platform that appears like networking hardware to the VMs 1008.

The VMs 1008 comprise virtual processing, virtual memory, virtual networking or interface and virtual storage, and may be run by a corresponding virtualization layer 1006. Different embodiments of the instance of a virtual appliance 1002 may be implemented on one or more of VMs 1008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1008 may be a software implementation of a physical machine that runs programs as if they were executing on a physical, non-virtualized machine. Each of the VMs 1008, and that part of hardware 1004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1008 on top of the hardware 1004 and corresponds to the application 1002.

Hardware 1004 may be implemented in a standalone network node with generic or specific components. Hardware 1004 may implement some functions via virtualization. Alternatively, hardware 1004 may be part of a larger cluster of hardware (e.g. such as in a data center or CPE) where many hardware nodes work together and are managed via management and orchestration 1010, which, among others, oversees lifecycle management of applications 1002. In some embodiments, hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1012 which may alternatively be used for communication between hardware nodes and radio units.

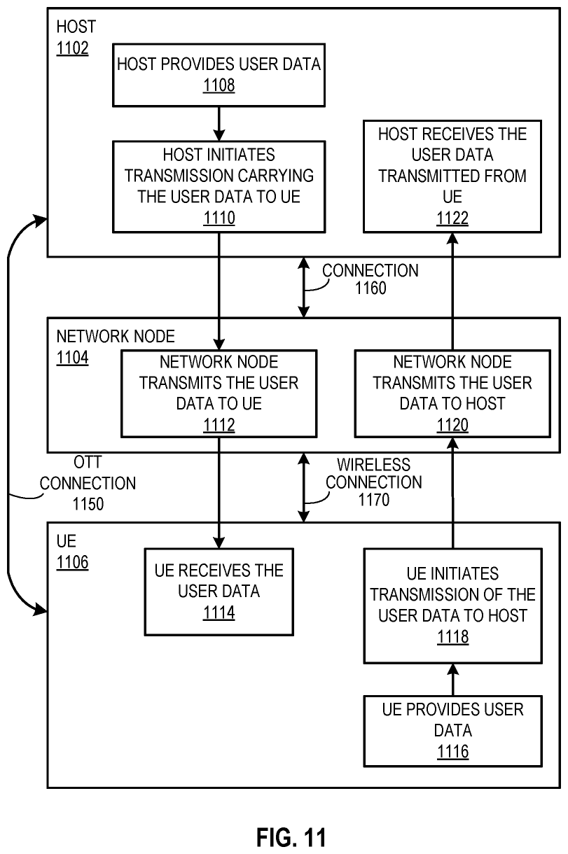

FIG. 11 shows a communication diagram of a host 1102 communicating via a network node 1104 with a UE 1106 over a partially wireless connection in accordance with some embodiments. Example implementations, in accordance with various embodiments, of the UE (such as a UF 612a of FIG. 6 and/or UF 700 of FIG. 7), network node (such as network node 610a of FIG. 6 and/or network node 800 of FIG. 8), and host (such as host 616 of FIG. 6 and/or host 900 of FIG. 9) discussed in the preceding paragraphs will now be described with reference to FIG. 11.

Like host 900, embodiments of host 1102 include hardware, such as a communication interface, processing circuitry, and memory. The host 1102 also includes software, which is stored in or accessible by the host 1102 and executable by the processing circuitry. The software includes a host application that may be operable to provide a service to a remote user, such as the UE 1106 connecting via an over-the-top (OTT) connection 1150 extending between the UE 1106 and host 1102. In providing the service to the remote user, a host application may provide user data which is transmitted using the OTT connection 1150.

The network node 1104 includes hardware enabling it to communicate with the host 1102 and UE 1106. The connection 1160 may be direct or pass through a core network (like core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by UE 1106 and executable by the UE's processing circuitry. The software includes a client application, such as a web browser or operator-specific “app” that may be operable to provide a service to a human or non-human user via UE 1106 with the support of the host 1102. In the host 1102, an executing host application may communicate with the executing client application via the OTT connection 1150 terminating at the UE 1106 and host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via a connection 1160 between the host 1102 and the network node 1104 and via a wireless connection 1170 between the network node 1104 and the UE 1106 to provide the connection between the host 1102 and the UE 1106. The connection 1160 and wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104, in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR or AR which it can broadcast, multicast or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1150 between the host 1102 and UE 1106, in response to variations in the measurement results. The measurement procedure and/or the network functionality for reconfiguring the OTT connection may be implemented in software and hardware of the host 1102 and/or UE 1106. In some embodiments, sensors (not shown) may be deployed in or in association with other devices through which the OTT connection 1150 passes; the sensors may participate in the measurement procedure by supplying values of the monitored quantities exemplified above, or supplying values of other physical quantities from which software may compute or estimate the monitored quantities. The reconfiguring of the OTT connection 1150 may include message format, retransmission settings, preferred routing etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency and the like, by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

[1] 3GPP TS 23.501 v17.5.0
[2] 3GPP TR 22.839
[3] 3GPP TR 23.700-05 v0.3.0 Study on VMR (Release 18)
[4] 3GPP TS 23.502 v17.5.0
[5] 3GPP TS 38.413 v17.1.1
[6] 3GPP TS 29.503 v17.7.0
[7] 3GPP TS 29.522 v17.6.0
[8] 3GPP TS 24.501 v17.7.1

1. A method performed by a user equipment, UE, comprising:
receiving a closed access group, CAG, configuration from a wireless communication network;
receiving extended CAG configuration information that indicates a validity condition under which the CAG configuration should be considered valid or not valid by the UE; and
applying the CAG configuration based on the indicated validity condition.

2. The method according to claim 1, wherein the extended CAG configuration information comprises a time duration during which the CAG configuration received should be considered valid by the UE.

3. The method of claim 2, wherein the CAG configuration comprises a plurality of CAG IDs, and wherein the time duration is common for all CAG IDs received by the UE.

4. The method of claim 2, wherein the time duration is measured by a one-shot timer, wherein the CAG configuration is not valid after expiration of the one-shot timer.

5. The method of claim 2, wherein the time duration is measured by a timer started by the UE upon receiving the CAG configuration for a first time, and, when the timer expires, is restarted again upon an indication from the network.

6. The method of claim 2, wherein the time duration is measured by a timer that is started only upon an indication from the network.

7. The method of claim 1, wherein the validity condition comprises at least one of:
a geographical location in which the CAG configuration received should be considered valid by the UE;
a tracking area, TA, or a list of TAs, where the CAG configuration received should be considered valid by the UE;
a registration area, RA, or a list of RAs, where the CAG configuration received should be considered valid by the UE;
a radio access node, RAN, notification area, RNA, or a list of RNAs, where the CAG configuration received should be considered valid by the UE; or
an indication for the UE where the CAG configuration received should be considered valid, or not valid, by the UE.

8. The method of claim 7, wherein the geographical location comprises a list of geographical coordinates.

9. The method of claim 7, wherein the geographical location comprises a set of geographical coordinates that represent a certain area.

10. The method of claim 1, wherein the extended CAG configuration information applies to a single CAG ID configured at the UE.

11. The method of claim 1, wherein the CAG configuration comprises a plurality of CAG IDs, and wherein the extended CAG configuration information is common for all CAG IDs received by the UE.

12. The method of claim 1, wherein the extended CAG configuration is received from a mobile integrated access and backhaul, IAB, node.

13. The method of claim 12, wherein the extended CAG configuration is received in a container generated by an access and mobility function, AMF.

14. The method of claim 1, further comprising:
providing user data; and
forwarding the user data to a host via the transmission to the network node.

15. The method of claim 1, wherein the extended CAG configuration information is received in non-access stratum, NAS, signalling.

16. The method of claim 1, wherein the extended CAG configuration is received in radio resource control, RRC, signalling.

17. A method performed by a network node of a wireless communication system, comprising:
sending a closed access group, CAG, configuration to a user equipment, UE; and
sending extended CAG configuration information to the UE that indicates a validity condition under which the CAG configuration should be considered valid or not valid by the UE.

18. The method according to claim 17 wherein the extended CAG configuration information comprises a time duration during which the CAG configuration received should be considered valid by the UE.

19. The method of claim 18, wherein the CAG configuration comprises a plurality of CAG IDs, and wherein the time duration is common for all CAG IDs received by the UE.

20. The method of claim 18, wherein the time duration is measured by a one-shot timer, wherein the CAG configuration is not valid after expiration of the one-shot timer.

21. The method of claim 18, wherein the time duration is measured by a timer that is started by the UE upon receiving the CAG configuration for a first time, and, when the timer expires, is restarted again upon an indication from the network.

22. The method of claim 18, wherein the time duration is measured by a timer that is started only upon an indication from the network.

23. The method according to claim 17, wherein the extended CAG configuration information comprises at least one of:
a geographical location in which the CAG configuration received should be considered valid by the UE;
a tracking area, TA, or a list of TAs, where the CAG configuration received should be considered valid by the UE;
a registration area, RA, or a list of RAs, where the CAG configuration received should be considered valid by the UE;
a radio access node, RAN, notification area, RNA, or a list of RNAs, where the CAG configuration received should be considered valid by the UE; or
an indication for the UE where the CAG configuration received should be considered valid, or not valid, by the UE.

24. The method of claim 23, wherein the geographical location comprises a list of geographical coordinates.

25-36. (canceled)

37. A user equipment, UE, comprising:
a processing circuit;
a transceiver coupled to the processing circuit; and
a memory coupled to the processing circuit, the memory comprising computer-readable programming instructions that, when executed by the processing circuit, cause the UE to perform operations comprising:
receiving a closed access group, CAG, configuration from a wireless communication network;
receiving extended CAG configuration information that indicates a validity condition under which the CAG configuration should be considered valid or not valid by the UE; and
applying the CAG configuration based on the indicated validity condition.

37. (canceled)

39. A network node, comprising:
a processing circuit;
a transceiver coupled to the processing circuit; and
a memory coupled to the processing circuit, the memory comprising computer-readable programming instructions that, when executed by the processing circuit, cause the network node to perform operations comprising:
sending a closed access group, CAG, configuration to a user equipment, UE; and
sending extended CAG configuration information to the UE that indicates a validity condition under which the CAG configuration should be considered valid or not valid by the UE.

40. (canceled)
